(19) United States
(12) Patent Application Publication
(10) Pub. No.: US 2018/0121925 A1
(43) Pub. Date: May 3, 2018

(54) METHOD AND DEVICE FOR MAKING A PAYMENT TRANSACTION

(71) Applicant: MASTERCARD INTERNATIONAL INCORPORATED, Purchase, NY (US)

(72) Inventors: Tushar Uddhav Gaikar, Mumbai (IN); Siddhesh Pangam, Dist-Sindhudurg (IN); Karabi Ghanta, Pune (IN)

(21) Appl. No.: 15/798,837

(22) Filed: Oct. 31, 2017

(30) Foreign Application Priority Data
Nov. 2, 2016 (SG) 10201609190T

(51) Int. Cl. G06Q 20/40; G06Q 20/32; G06Q 20/38; H04L 29/06

(52) U.S. Cl. CPC G06Q 20/40145; G06Q 20/322; H04L 63/0838; G06Q 20/382; G06Q 20/3278

(57) ABSTRACT

A method and device for making a payment transaction over a payment network are provided. The method employs a communication device associated with a consumer, and has a radio frequency (RF) communication module. The method includes receiving, by the communication device, a request for an input of payment account data in respect of the payment transaction, reading, by the communication device in response to the request, the payment account data from a payment card using the RF communication module, and transmitting the payment account data to the payment network for processing the payment transaction. Devices and non-transitory computer-readable medium storing computer-readable instructions that, when executed, cause a processor to carry out the method are also provided.

### CROSS REFERENCE TO RELATED APPLICATIONS

This patent application claims priority to Singapore Application No. 10201609190T filed on Nov. 2, 2016, the disclosure of which is incorporated by reference herein in its entirety as part of the present application.

### BACKGROUND

The present disclosure relates to a method and device for making a payment transaction, and in particular for making an electronic payment transaction over a payment network using a communication device associated with a cardholder.

When consumers make an online purchase for products from a merchant's website (via a web-browser or via a dedicated online shopping mobile-application), electronic payment options such as by credit cards or debit cards may be available to the consumer. At the payment stage, the website or application may prompt the consumer to enter his or her payment information such as credit card details via a user interface. The payment information and an amount of purchase are included in a transaction request that is then sent for processing over a payment network. The purchase is completed upon successful authorization of the transaction by the issuing bank of the credit card. The payment information required from the consumer (in case of a credit card) typically includes the credit card number (also known as a primary account number PAN), a name of the cardholder, an expiry date/month, a card security code (CSC, also known as card verification data (CVD), card verification value (CVV) or the like), and/or a billing address. However, this process may be tedious and time-consuming as the consumer may be required manually enter the above information each time a payment transaction is to be made, which is also prone to error.

Some websites or mobile-applications may store the consumers' payment information in a database (if the consumers agree to) for their future purchases so that the payment information may be auto-populated from the database, instead of being manually entered by the consumers anew each time. However, this is only useful when the consumer makes repeated purchases from the merchant or website. In other words, if the consumer is making a purchase with a new merchant or at a new website for the first time, payment information still needs to be manually entered regardless. Moreover, storing sensitive payment information may pose security risks for both the merchant and the consumers. For example, the consumers may be reluctant to agree to this arrangement due to security concerns, and often still have to manually enter card details for every payment transaction made.

Therefore, it is desirable to provide an improved method and device for making a payment transaction.

### BRIEF DESCRIPTION

The present disclosure provides using a Radio Frequency Identification (RFID) enabled communication device of a cardholder to obtain payment account data of his or her payment card by a RF communication protocol for a payment transaction made via the communication device, such as for, but is not limited to, an online purchase made using the communication device. The RFID-enabled communication device may include, but is not limited to, a near-field communication (NFC) enabled communication device, such as a NFC-enabled mobile phone of the cardholder.

A first aspect of the present disclosure provides a method of making a payment transaction over a payment network. The method is performed by a communication device of a cardholder of a payment card. The communication device has a radio frequency (RF) communication module. The method includes receiving, by the communication device, a request for an input of payment account data in respect of the payment transaction, reading, by the communication device in response to the request, the payment account data from the payment card using the RF communication module, and transmitting the payment account data from the communication device to the payment network for processing the payment transaction.

Typically, the communication device is a portable communication device of the cardholder, such as a mobile phone, a tablet, or a smart watch of the cardholder.

As used in this document, the term “payment card” refers to any cashless payment device associated with a payment account, such as a credit card, a debit card, a prepaid card, a charge card, a membership card, a promotional card, a frequent flyer card, an identification card, a gift card, and/or any other device that may hold payment account information, such as mobile phones, Smartphones, personal digital assistants (PDAs), key fobs, transponder devices, NFC-enabled devices, and/or computers.

The payment account may be a bank account such as a credit card, a debit card, loan, checking, and/or savings account, having a primary account number (PAN) maintained by a bank (e.g. the “issuer”, or “issuing bank”). The PAN functions as payment credentials used when making a payment. Conventionally, the PAN is a 16-digit PAN number, which, if a physical card (typically a plastic card) exists, is printed on the card. However, a payment card can be used in the present disclosure irrespective of whether a physical card bearing the payment credentials exists. For example, a digital wallet (e.g. a wallet application running on such device) may store or be linked to payment account information associated with a credit card or debit card which an owner holds. The payment account data may include one or more of the following: a PAN, a name of the cardholder, an expiry date/month, a card security code (CSC, also known as card verification data (CVD), card verification value (CVV) or the like), a billing address, information associated with the issuing bank, and the like.

This may allow for the payment account data of the payment card to be obtained by the cardholder's communication device quickly and accurately via a RF communication protocol, without requiring the cardholder to manually inputting the payment account data on the communication device. Accordingly, it may allow the payment account data to be provided and/or made available to the communication device expeditiously with minimal user interaction. For example, the user may only need to bring the communication device in close proximity to his or her payment card, or vice versa. Significantly, this may not only help alleviate the burden of the cardholder to manually input card details, but also eliminate the need for the website and/or the merchant to store consumer's card details thereby further reducing security risks and/or security standard compliance obligations.

In some embodiments, the method may include receiving a one-time-password (OTP) from a server associated with an issuer of the payment card. In response, the communication device transmits a corresponding OTP to the server for authorizing the payment transaction to be effected over the payment network. The issuer of the payment card is typically a financial institution at which the cardholder holds an associated payment account.

In some embodiments, the RF communication module may be a near-field communication (NFC) module. For example, the NFC module is configured to fetch the payment account data from the payment card via a NFC protocol. According to a particular example, the NFC module is operable to establish communication with a target in its proximity such as within about 4 cm (or 2 inches).

In some embodiments, the method may include receiving an input of biometric data from the cardholder on the communication device for verification. The verification is carried out against reference biometric data associated with the cardholder stored by the payment card. In particular, it is determined if the biometric data received by the communication devices matches the reference biometric data. The method may include obtaining the payment account data only in response to a positive verification. The biometric data of the cardholder may be a retina/iris scan, a finger print, and/or a voice sample of the cardholder.

In some embodiments, the obtained payment account data may be stored in a secure memory of the communication device. The method may include allowing retrieval of the payment account data from the secure memory in response to an authentication message, and denying retrieval thereof otherwise.

In some embodiments, the communication device has a first application installed via which the payment transaction is to be carried out. The method may include receiving the request for the input of payment account data via the first application, generating the authentication message based on the payment transaction, and allowing retrieval of the payment account data by the first application using the authentication message. For example, the authentication message is generated by the first application using the data associated with the particular payment transaction, such as a unique transaction ID or token.

In some embodiments, the payment transaction is for a purchase of products made by a cardholder via the first application. In particular, the payment transaction is for an order of products on an online-shopping website via a web-browser or a dedicated online-shopping mobile application on the cardholder's mobile phone. The product may include any of physical objects, data products (such as music or software) or services. In another example, the payment transaction is a bill payment transaction made via the mobile phone.

In some embodiments, the method may include automatically populating the payment account data in the first application for display to the cardholder on the communication device.

In some embodiments, the method may include removing the payment account data from the communication device after the operation of transmitting the payment account data. The removal of the payment account data may be performed in response to a notification of the payment transaction being successful. For example, the communication device may be notified by the issuer server and/or the first application that the transaction has been approved.

A second aspect of the present disclosure provides a communication device for making a payment transaction. The communication device has a radio frequency (RF) communication module, a processor, and a data storage device storing program instructions being operative to cause the processor to carry out any one of the method described above. In particular, there is provided a communication device for use by a cardholder of a payment card for making a payment transaction over a payment network. The communication device includes a radio frequency (RF) communication module, a processor, and a data storage device storing program instructions, the program instructions being operative to cause the processor to receive, by the communication device, a request for an input of payment account data in respect of the payment transaction, obtain, by the communication device in response to the request, the payment account data of the payment card using the RF communication module, and transmit the payment account data from the communication device to the payment network for processing the payment transaction.

A third aspect of the present disclosure provides a non-transitory computer-readable medium storing computer-readable instructions that, when executed, cause a processor of a communication device associated with a consumer to perform steps of a method for making a payment transaction over a payment network according to any one of the methods described above. In particular, A non-transitory computer-readable medium storing computer-readable instructions that, when executed, cause a processor of a communication device of a cardholder of a payment card to perform steps of a method for making a payment transaction over a payment network, the method including receiving, by the communication device, a request for an input of payment account data in respect of the payment transaction, obtaining by the communication device in response to the request, the payment account data of the payment card using the RF communication module, and transmitting the payment account data from the communication device to the payment network for processing the payment transaction.

The present disclosure further provides a software product, such as at a time when it is stored in a non-transitory form on a tangible data storage device. The data storage device may be within a communication device of a consumer, or it may be a database from which the communication device is able to download the software. In particular, there is provided a program product including computer program instructions which is operative, when implemented by a processor of a communication device, to cause the processor to perform any one of the methods described above.

All operations of the provided methods may be performed automatically. The term “automatic” is used in this document to refer to a process which is performed substantially without human involvement, save possibly for initiation of the process.

As used in this document, the term “Radio Frequency Identification” or “RFID” refers to an automatic identification technology which uses radio-frequency electromagnetic fields to identify objects carrying RFID tags when they come close to an interrogator (also known as a base station or more generally, reader. RFID technology may employ different RFID frequency bands and be operated in a variety of communication ranges, such as up to 10 cm (Low Frequency, LF), up to 30 cm (High Frequency, HF) or even up to 100 m (Ultra High Frequency, ULF). Typically, the RFID tag contains at least one microchip (e.g. an integrated circuit (IC)) and an antenna in order to pass information onto the reader. The microchip stores information and is responsible for managing the radio frequency communication with the reader. The tag may be passive which does not have an independent energy source and depend on an external electromagnetic signal, provided by the reader, to power their operations. Alternatively, the tag may be active which contains an independent energy source, such as a battery. An example of RFID is near-field communication (NFC) which employs radio waves communication protocols that allow communication between data communication couplers (e.g. a NFC tag and reader) when they are brought into proximity to a pre-defined distance. The distance may be up to 15 cm, up to 10 cm, up to 5 cm, up to 4 cm or less.

Within the scope of this disclosure it is expressly intended that the various aspects, embodiments, examples and alternatives set out in the preceding paragraphs, in the claims and/or in the following description and drawings, and in particular the individual features thereof, may be taken independently or in any combination. Features described in connection with one embodiment are applicable to all embodiments, unless such features are incompatible.

### BRIEF DESCRIPTION OF THE DRAWINGS

Embodiments of the disclosure will now be described by way of example only with reference to the following drawings, in which:

FIG. 1 shows a computerized network which is suitable to perform a method according to the present disclosure;

FIG. 2 is a flow diagram of an exemplary method according to one embodiment;

FIG. 3 is a flow diagram of an exemplary method according to another embodiment;

FIG. 4 shows the technical architecture of a server of the computerized network of FIG. 1; and

FIG. 5 shows the technical architecture of a communication device of the system of FIG. 1.

### DETAILED DESCRIPTION

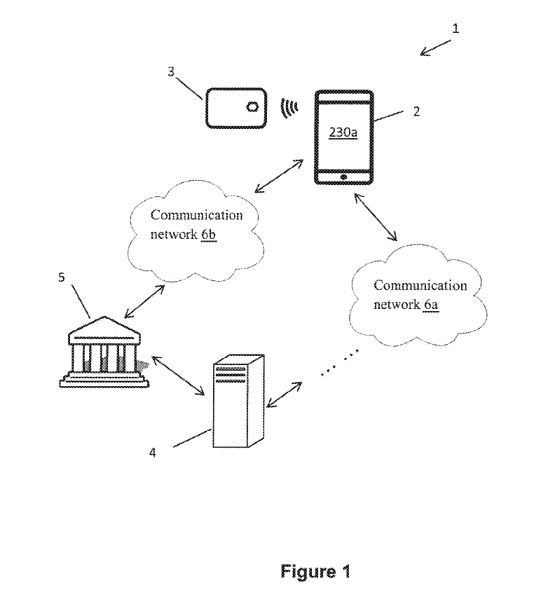

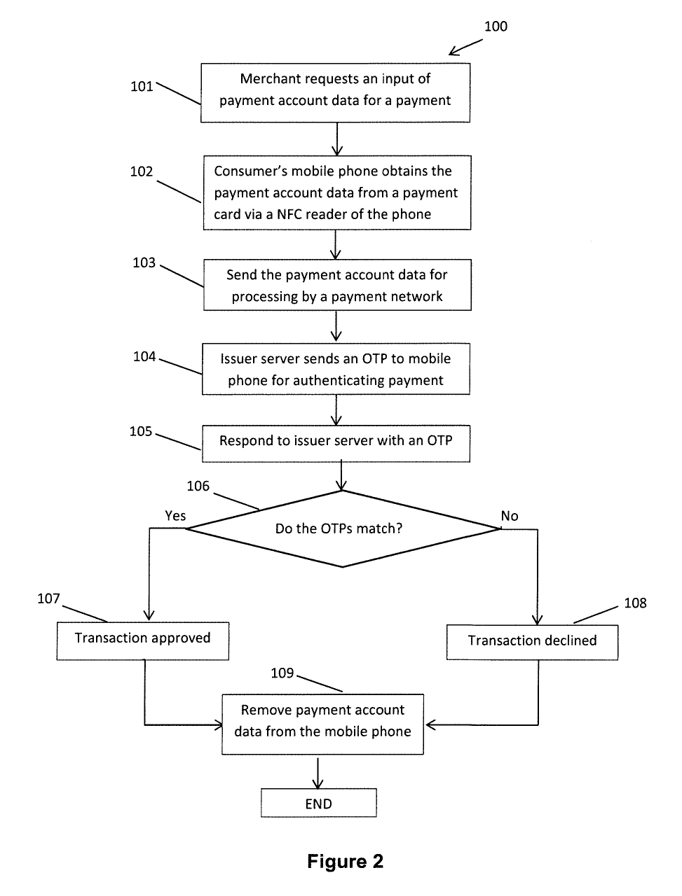

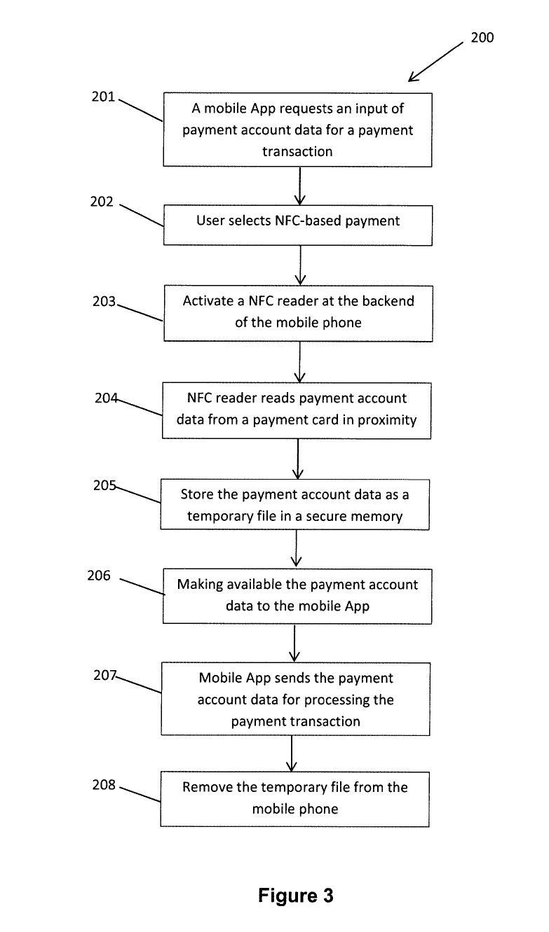

Referring to FIG. 1, a computerized network 1 is shown which is suitable for performing methods of embodiments as illustrated by FIG. 2 and FIG. 3.

The computerized network 1 includes a communication device in a form of a mobile phone 2 of a cardholder for making a payment transaction over a payment network using a payment card 3, and a payment network server 4 which in communication with an issuer system such as an issuing bank server 5 operated by an issuing bank. The payment network server 4 is also in communication with an acquirer system such as an acquiring bank server operated by an acquiring bank of a merchant (not shown).

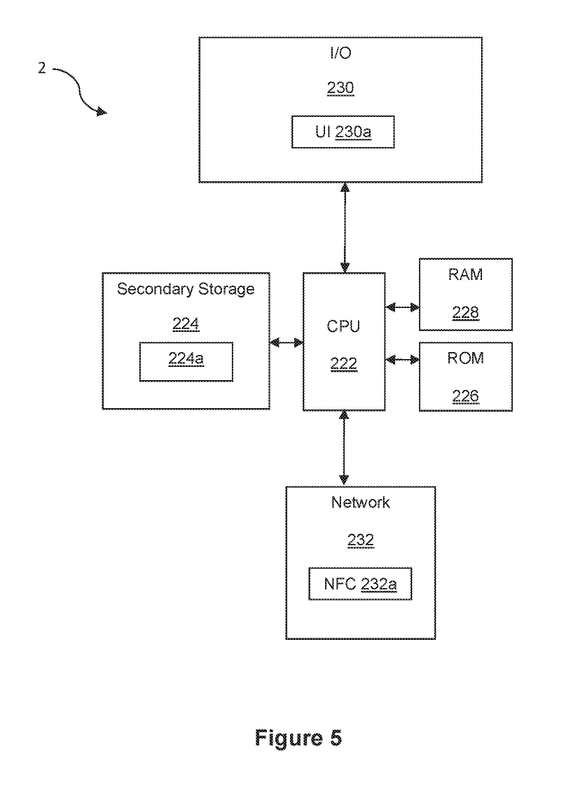

The mobile phone 2 facilitates an electronic payment transaction between a cardholder of and a merchant. The mobile phone 2 has a radio frequency (RF) communication module in a form of a near-field communication (NFC) reader 232a (as shown in FIG. 5). The NFC reader 232a is capable of reading data from a suitable data storage device via a NFC protocol. As will be understood by a skilled person in the art, NFC is a set of short-range wireless technologies, typically involving an initiator (such as an NFC reader) and a target (such as a powered or unpowered NFC tag). The working range of communication may be up to 5 cm, or 10 cm. In particular, the NFC 232a is configured to read payment account data from a NFC-enabled payment card (e.g. the payment card 3 which functions as a passive NFC tag) which stores the payment account data. In another example, the payment card 3 may include a battery source and may function as an active NFC tag.

The mobile phone 2 is typically in communication with the issuing bank server 5 to receive relevant communication associated with payment transactions via a communication network 6b. For example, the issuing bank server 5 may request authentication from the cardholder via a registered mobile phone (e.g. the mobile phone 2) of the cardholder before authorizing the transaction as will be described below. The mobile phone 2 has a graphic user interface 230a for communication information to the user of the mobile phone 2. In this example, the graphic user interface 230a is also an input terminal which allows a user's input to be received.

The payment card 3 may be a credit card or debit card. The payment card 3 stores payment account data associated with the payment card. The data is readable via a radio frequency (RF) communication protocol. In some embodiments, the data is readable via a NFC protocol which allows the data to be retrieved or obtained by the NFC reader 232a placed in proximity to the payment card 3. The payment account data may include card details such as a PAN, a name of the cardholder, an expiry date/month, a CVC/CVV of the card, a billing address, and/or information associated with the issuing bank. The payment account data may be stored, read, or otherwise communicated in an encrypted or tokenized format.

In this embodiment, the payment network server 4 is configured to processes the payment transaction between the cardholder and the merchant at which an online purchase is made via a web-browser of the mobile phone 2. In particular, the mobile phone 2 of the cardholder is configured to communicate payment card details associated with the payment card 3 for processing a payment transaction by the payment network server 4. This process typically involves the mobile phone 2 transmitting the payment card details to a merchant's server (not shown) via a communication network 6a. The merchant's server then prepares a transaction request including data indicative of the amount of the purchase to a server of the acquiring bank at which the merchant maintains an account. In another possibility, a payment gateway associated with the merchant may allow the transaction data to be sent directly from the web-browser to the gateway, bypassing the merchant's systems. The acquirer bank server then contacts the payment network server 4, and passes on the payment card details and the amount of the purchase. The payment network server 4 contacts the issuing bank server 5, and sends it the payment card details and the amount of the purchase. The issuing bank server 5 decides either to authorize the purchase, or not to, and sends a corresponding message to the payment network server 4. If the issuing bank server 3 authorized the transaction, then the purchase is completed. At some later time (during clearing and settlement operations), the issuing bank transfers the payment amount to the acquiring bank. As will be understood by a skilled person in the art, the payment network server 1 may be constituted by a payment processing organization such as MasterCard, having suitable processing apparatus. Typically, the transmission, storage and/or other processing of transaction data such as the payment card details may be encrypted and/or tokenized for security purposes.

As will be understood by a skilled person in the art, each of the device and servers 2, 4, 5 in the computerized network 1 has a communication module such as wireless interface for two-way communication between one and another via a communication network. The communication network could be any types of network, for example, virtual private network (VPN), the Internet, a local area and/or wide area network (LAN and/or WAN), and so on. Although the computerized network 1 shows only one mobile phone 2 and issuing bank server 5, it will be understood that there may be a plurality of them in the network 1.

Exemplary methods of the present disclosure will now be illustrated with reference to FIGS. 2-3 in which the operations are enumerated. It should also be noted that enumeration of operations is for purposes of clarity and that the operations need not be performed in the order implied by the enumeration.

Referring to FIG. 2, an exemplary method 100 will be described with reference to a payment transaction for a purchase of products made by a consumer using his or her mobile phone 2 at a merchant's website using the payment card 3. It will be understood that the method 100 may also apply to other payment transactions such as online bill payment via the mobile phone 2. In this particular example, the consumer places an order of the products on the merchant's website via a web-browser of the mobile phone. In another example, the order may be placed via a dedicated online-shopping application provided by the merchant that is installable by the mobile phone 2, such as ones provided by Amazon.com®, eBay™ or the like.

At step 101, a webserver of the merchant requests an input of payment account data for a payment at a check-out page. In one embodiment, the request is received by the web-browser of the mobile phone 2 and is communicated to the consumer via a graphic display rendered on the merchant's website via the graphic user interface 230a of the mobile phone 2. The check-out page may provide a plurality of payment options including credit card or debit card payment. For a payment option, the merchant's website may display information fields which need to be filled in or otherwise required in relation to the payment option for the payment transaction. For example, the information fields required of a credit card payment may include a PAN, a name of the cardholder, an expiry date/month, a CVC/CVV of the card, a billing address. Moreover, the consumers may be prompted with different options of provision of card details, especially if the consumer has chosen the payment option by payment cards. For example, the consumer may be presented with an option to allow automatic population of the card details on the website based on payment account data fetched by the NFC reader 232a of the mobile phone 2 upon placing in proximity to the payment card 3. The consumer may also choose to enter the card details manually.

If the consumer opts for automatic population of the card details, the mobile phone 2 is configured to obtain the payment account data from the payment card 3 via the NFC reader 232a of the mobile phone 2 at step 102. In particular, the NFC reader 232a may be activated to fetch card details from a payment card in proximity via the NFC protocol. The card details stored by the payment card 3 may include a credit card number, a name of the cardholder, an expiry date, a card security code, a billing address, and/or other payment related information which may be required to carry out a typical payment transaction.

At step 103, the mobile phone 2 sends the card details to the merchant for processing the payment transaction by the payment network. For example, the payment account data may be transmitted to the merchant's webserver via the website, and the merchant prepares the transaction request for processing over the payment network. In another possibility, a payment gateway associated with the merchant may allow the transaction data to be sent directly from the web-browser to the gateway, bypassing the merchant's systems. The transaction request typically includes the payment account data and an amount of purchase and is sent to the payment network server 4 via the acquiring bank server. In response to the transaction request, the payment network server 4 identifies the issuing bank at which the payment account is being held and sends the transaction request to the issuer bank of the card for authorizing of the payment transaction.

Typically, in response to the transaction request received, the issuing bank server 5 generates and sends a one-time-password (OTP) to a registered communication device (typically the mobile phone 2 of the consumer) of the cardholder to authenticate the payment at step 104. At step 105, the cardholder's mobile phone 2 receives the OTP from the issuing bank server 5, and responds with a corresponding OTP to authenticate the payment transaction. The corresponding OTP input by the mobile phone 2 may be identical (but not necessarily) to the OTP received from the issuing bank server 5. For example, in certain circumstances, the OTP received may include a string of alphanumerical characters, and the cardholder may be prompted to respond by inputting only the numerical characters. This may be performed by the cardholder inputting the corresponding OTP on the mobile phone 2, for example, via an application program interface (API) operated by the issuing bank or the payment network. This helps to verify that the payment transaction is instructed or carried out by a legitimate cardholder of the payment card 3. Accordingly, if an unauthorized person attempts to carry out the payment transaction using the payment card 3, the person would not be able to receive and/or provide the OTP for subsequent authentication by the issuing bank server 5.

At step 106, the issuer bank determines whether the two OTPs match, and if so, the transaction is approved at step 107. If the OTPs fail to match, the transaction is declined by the issuing bank at step 108. This effectively prevents unauthorized transactions made in connection with a payment card whose card details having been obtained by a NFC reader in the vicinity without the cardholder's consent and/or permission. This also allows for the process to utilize existing security processes for preventing unauthorized transactions.

The consumer may be notified of the outcome of the transaction by the issuing bank directly or via the merchant's website. At step 109, the card details are removed from the mobile phone 2. This helps prevent other applications or devices from accessing the card details post transactions. Accordingly, this may enhance the security and safety associated with the proposed process.

FIG. 3 illustrates a flow of another exemplary method 200 of the present disclosure. The method 200 is described with respect to an electronic payment transaction for a bill payment made via a mobile application running on the mobile phone 2. The payment transaction is made by a payment card 3, which may be a debit card, credit card, prepaid card, or any other type of card that is associated with a payment account. It will be understood that the method 200 may also apply to other payment transactions such as for an online purchase made with a merchant. In this example, the issuing bank is the financial institution at which the cardholder holds an associated payment account for funding the bill payment.

At step 201, the mobile application requests an input of payment account data for the payment transaction. In one embodiment, the request is received by the mobile phone 2 and is communicated to the cardholder via a graphic display rendered on the mobile application via the user interface 230a. The cardholder may be provided with different options of provision of the card details. For example, the cardholder may be prompted to allow automatic input of the card details based on payment account data fetched by the NFC reader 232a of the mobile phone 2. The cardholder may also choose to enter the card details manually.

In the example illustrated by FIG. 3, the cardholder selects the NFC-based payment at step 202. In response to the selection, the mobile phone 2 is configured to activate the NFC reader 232a at the backend at step 203 for reading payment account data via a NFC protocol. The card details stored by the payment card 3 may include a card number, a primary account number, a name of the cardholder, an expiry date, a card security code, a billing address, and/or other payment related information which may be required to carry out a typical payment transaction.

At step 204, the cardholder places his or her mobile phone 2 in close proximity to a payment card to fetch the associated payment account data stored on the payment card 3. This may be performed in a similar way as step 102 of the method 100.

In another embodiment, step 204 may include a step of requesting an input of biometric data from the user of the mobile phone 2, such as a fingerprint, for verification against the payment card 3, prior to the payment account data being obtained by the mobile phone 2. The payment card 3 may store biometric data associated with the cardholder of the payment card 3 for verification. In particular, it may be determined if the input of the biometric data on the mobile phone 2 matches the biometric data of the cardholder. In one example, the biometric data stored by the payment card 3 is accessible by the NFC reader 232a of the mobile phone 2, and the comparison made by carried out by the mobile phone 2. The mobile phone 2 may be configured to obtain the payment account data in response to a positive verification. The biometric data may be a retina/iris scan, a fingerprint, and/or a voice sample of the cardholder. The mobile phone 2 has a necessary input terminal for detecting a biometric sample from a user of the mobile phone 2.

At step 205, the mobile phone 2 stores the fetched payment account data as a temporary file in a secure memory of the mobile phone 2. In some embodiments, the secure memory may be configured to only allow access to the stored data (e.g. the payment account data) in response to an authentication message, and may deny retrieval of the payment account data otherwise. For example, the authentication message may be associated with a particular payment transaction to be carried out, as will be described below.

At step 206, the mobile phone 2 makes available the stored payment account data to the mobile application via which the payment transaction is to be carried out. The stored payment account data is made accessible only in response to an authentication message. According to one embodiment, in response to the cardholder selecting the NFC-based payment at step 202, a unique identifier is generated in respect of the payment transaction. The unique identifier may be used by the mobile application as the authentication message for accessing the secure memory. In other words, a unique identifier is generated at each time the NFC reader 232a is activated to fetch the payment account data. Accordingly, it permits only the mobile application which is associated with the particular payment transaction to access the secure memory to retrieve the payment account data using the unique identifier. This further enhances the security of the process so that the payment account data stored in the temporary file cannot be read or retrieved any other mobile applications or devices.

At step 207, the mobile application sends the payment account data out of the mobile phone 2 for processing the payment transaction over the payment network. At step 208, the temporary file is removed from the mobile phone 2.

In the embodiments described above, the card details may be auto-populated on the merchant's website or the mobile application by the mobile phone 2. In particular, the card details may be displayed to the user of mobile phone 2 via the graphic user interface 230a in text or in other user-readable form for verification of the card details by the cardholder. The card details are transmitted out of the mobile phone 2 in response to the cardholder confirming the payment details.

In a variant embodiment, not all card details are displayed in text or in other user-readable form to the user, for security purposes. For example, in one example, only the bank name and/or the card name is displayed in text to the user of the mobile phone 2. Other card details such as the primary account number, the card number, the expiry date/month and the CVV/CVC number may not be displayed, or displayed in a hidden form (such as dots, asterisks, or the like). This may prevent unauthorized person from obtaining and learning the card details by bringing his or her mobile phone 2 in close proximity to a payment card without the cardholder's consent and/or permission. Accordingly, the unauthorized person is unable to avail oneself of the card details for other transactions (e.g. those transactions which may not require OTP authorization by the issuing bank).

In the embodiments described above, the selection of NFC-based payment at step 202 may be made by the user of the mobile phone 2. In another embodiment, the mobile phone 2 may be configured to automatically activate the NFC reader 232a by default in response to a request of an input of payment account data, which is received from the merchant's website or the mobile application. In a further embodiment, the activation mechanism of the NFC reader 232a may be pre-configurable by the user of the mobile phone 2.

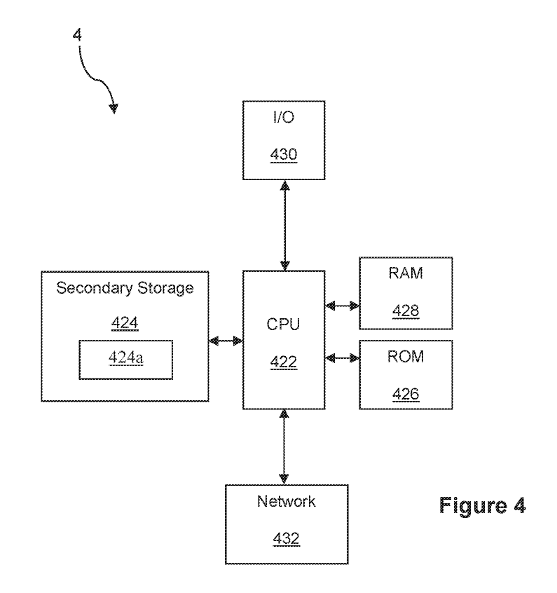

FIG. 4 is a block diagram showing a technical architecture of a server computer (e.g. the payment network server 4 or the issuing bank server 5) suitable for implementing the present method.

The technical architecture includes a processor 422 (which may be referred to as a central processor unit or CPU) that is in communication with memory devices including secondary storage 424 (such as disk drives), read only memory (ROM) 426, random access memory (RAM) 428. The processor 422 may be implemented as one or more CPU chips. The technical architecture may further include input/output (I/O) devices 430, and network connectivity devices 432.

The secondary storage 424 typically includes one or more disk drives or tape drives and is used for non-volatile storage of data and as an over-flow data storage device if RAM 428 is not large enough to hold all working data. Secondary storage 424 may be used to store programs which are loaded into RAM 428 when such programs are selected for execution.

In this embodiment, the secondary storage 424 has a processing component 424a including non-transitory instructions operative by the processor 422 to perform various operations of the method of the present disclosure. The ROM 426 is used to store instructions and perhaps data which are read during program execution. The secondary storage 424, the RAM 428, and/or the ROM 426 may be referred to in some contexts as computer readable storage media and/or non-transitory computer readable media.

I/O devices 430 may include printers, video monitors, liquid crystal displays (LCDs), plasma displays, touch screen displays, keyboards, keypads, switches, dials, mice, track balls, voice recognizers, card readers, paper tape readers, or other well-known input devices.

The network connectivity devices 432 may take the form of modems, modem banks, Ethernet cards, universal serial bus (USB) interface cards, serial interfaces, token ring cards, fiber distributed data interface (FDDI) cards, wireless local area network (WLAN) cards, radio transceiver cards that promote radio communications using protocols such as code division multiple access (CDMA), global system for mobile communications (GSM), long-term evolution (LTE), worldwide interoperability for microwave access (WiMAX), near field communications (NFC), radio frequency identity (RFID), and/or other air interface protocol radio transceiver cards, and other well-known network devices. These network connectivity devices 432 may enable the processor 422 to communicate with the Internet or one or more intranets. With such a network connection, it is contemplated that the processor 422 might receive information from the network, or might output information to the network in the course of performing the above-described method operations. Such information, which is often represented as a sequence of instructions to be executed using processor 422, may be received from and outputted to the network, for example, in the form of a computer data signal embodied in a carrier wave.

The processor 422 executes instructions, codes, computer programs, scripts which it accesses from hard disk, floppy disk, optical disk (these various disk based systems may all be considered secondary storage 424), flash drive, ROM 426, RAM 428, or the network connectivity devices 432. While only one processor 422 is shown, multiple processors may be present. Thus, while instructions may be discussed as executed by a processor, the instructions may be executed simultaneously, serially, or otherwise executed by one or multiple processors.

Although the technical architecture is described with reference to a computer, it should be appreciated that the technical architecture may be formed by two or more computers in communication with each other that collaborate to perform a task. For example, but not by way of limitation, an application may be partitioned in such a way as to permit concurrent and/or parallel processing of the instructions of the application. Alternatively, the data processed by the application may be partitioned in such a way as to permit concurrent and/or parallel processing of different portions of a data set by the two or more computers. In an embodiment, virtualization software may be employed by the technical architecture to provide the functionality of a number of servers that is not directly bound to the number of computers in the technical architecture. In an embodiment, the functionality disclosed above may be provided by executing the application and/or applications in a cloud computing environment. Cloud computing may include providing computing services via a network connection using dynamically scalable computing resources. A cloud computing environment may be established by an enterprise and/or may be hired on an as-needed basis from a third-party provider.

It is understood that by programming and/or loading executable instructions onto the technical architecture, at least one of the CPU 422, the RAM 428, and the ROM 426 are changed, transforming the technical architecture in part into a specific purpose machine or apparatus having the novel functionality taught by the present disclosure. It is fundamental to the electrical engineering and software engineering arts that functionality that can be implemented by loading executable software into a computer can be converted to a hardware implementation by well-known design rules.

FIG. 5 is a block diagram showing a technical architecture of a communication device (e.g. the mobile phone 2). The technical architecture includes a processor 222 (which may be referred to as a central processor unit or CPU) that is in communication with memory devices including secondary storage 224 (such as disk drives or memory cards), read only memory (ROM) 226, random access memory (RAM) 228. The processor 222 may be implemented as one or more CPU chips. The technical architecture further includes input/output (I/O) devices 230, and network connectivity devices 232.

The I/O devices include a consumer interface (UI) 230. The UI 230a may include a screen in the form of a touch screen, a keyboard, a keypad, or other known input device.

The secondary storage 224 typically includes a memory card or other storage device and is used for non-volatile storage of data and as an over-flow data storage device if RAM 228 is not large enough to hold all working data. Secondary storage 224 may be used to store programs which are loaded into RAM 228 when such programs are selected for execution.

In this embodiment, the secondary storage 224 has a processing component 224a, including non-transitory instructions operative by the processor 222 to perform various operations of the method of the present disclosure. The ROM 226 is used to store instructions and perhaps data which are read during program execution. The secondary storage 224, the RAM 228, and/or the ROM 226 may be referred to in some contexts as computer readable storage media and/or non-transitory computer readable media.

The network connectivity devices 232 include a radio frequency communication module for RFID, and in particular a NFC communication module 232a in this embodiment. The mobile phone 2 may include further network connective devices 232 in the form of modems, modem banks, Ethernet cards, universal serial bus (USB) interface cards, serial interfaces, token ring cards, fiber distributed data interface (FDDI) cards, wireless local area network (WLAN) cards, radio transceiver cards that promote radio communications using protocols such as code division multiple access (CDMA), global system for mobile communications (GSM), long-term evolution (LTE), worldwide interoperability for microwave access (WiMAX), and/or other air interface protocol radio transceiver cards, and other well-known network devices. These network connectivity devices 232 may enable the processor 222 to communicate with the Internet or one or more intranets. With such a network connection, it is contemplated that the processor 222 might receive information from the network, or might output information to the network in the course of performing the above-described method operations. Such information, which is often represented as a sequence of instructions to be executed using processor 222, may be received from and outputted to the network, for example, in the form of a computer data signal embodied in a carrier wave.

The processor 222 executes instructions, codes, computer programs, scripts which it accesses from hard disk, floppy disk, optical disk (these various disk based systems may all be considered secondary storage 224), flash drive, ROM 226, RAM 228, or the network connectivity devices 232. While only one processor 222 is shown, multiple processors may be present. Thus, while instructions may be discussed as executed by a processor, the instructions may be executed simultaneously, serially, or otherwise executed by one or multiple processors.

Whilst the foregoing description has described exemplary embodiments, it will be understood by those skilled in the art that many variations of the embodiment can be made within the scope and spirit of the present disclosure. For example, it will be understood that the present method may also be applied to fund transfer applications such as peer-to-peer (P2P) payment transactions made between a payer and payee involving a payment card. For another example, the payment card may be another NFC-enabled device (other than a plastic card) which stores payment account information.

1. A method performed by a communication device of a cardholder of a payment card for making a payment transaction over a payment network, wherein the communication device has a radio frequency (RF) communication module, the method comprising:
receiving, by the communication device, a request for an input of payment account data in respect of the payment transaction;
reading, by the communication device in response to the request, the payment account data from the payment card using the RF communication module; and
transmitting the payment account data from the communication device to the payment network for processing the payment transaction.

2. The method according to claim 1 further comprising receiving a one-time-password (OTP) from a server associated with an issuer of the payment card, and in response transmitting a corresponding OTP to the server for authorizing the payment transaction.

3. The method according to claim 1, wherein the RF communication module is a near-field communication (NFC) module.

4. The method according to claim 3, wherein the NFC module is configured to fetch the payment account data from the payment card via a NFC protocol.

5. The method according to claim 1, further comprising receiving an input of biometric data from the cardholder on the communication device for verification against reference biometric data associated with the cardholder stored by the payment card, and obtaining the payment account data in response to a positive verification.

6. The method according claim 1, wherein obtaining the payment account data comprises storing the payment account data in a secure memory, and wherein the method further comprises allowing retrieval of the payment account data from the secure memory in response to an authentication message, and denying retrieval thereof otherwise.

7. The method according to claim 6, wherein the communication device has a first application installed via which the payment transaction is to be carried out, the method further comprising receiving the request for the input of payment account data via the first application, generating the authentication message based on the payment transaction, and allowing retrieval of the payment account data by the first application using the authentication message.

8. The method according to claim 7, wherein the payment transaction is for a purchase of products made by the cardholder via the first application.

9. The method according to claim 7, further comprising automatically populating the payment account data in the first application for display to the cardholder on the communication device.

10. The method according to claim 1, further comprising removing the payment account data from the communication device after the operation of transmitting the payment account data.

11. The method according to claim 10, further comprising removing the payment account data from the communication device in response to a notification of the payment transaction being successful.

12. A communication device for use by a cardholder of a payment card for making a payment transaction over a payment network, the communication device comprising a radio frequency (RF) communication module, a processor, and a data storage device storing program instructions, the program instructions being operative to cause the processor to:
receive, by the communication device, a request for an input of payment account data in respect of the payment transaction;
obtain, by the communication device in response to the request, the payment account data of the payment card using the RF communication module; and
transmit the payment account data from the communication device to the payment network for processing the payment transaction.

13. The communication device according to claim 12, the program instructions being operative to cause the processor to receive a one-time-password (OTP) from a server associated with an issuer of the payment card, and in response, to transmit a corresponding OTP to the server for authorizing the payment transaction.

14. The communication device according to claim 12, wherein the RF communication module is a near-field communication (NFC) module.

15. The communication device according to claim 14, wherein the NFC module is configured to fetch the payment account data from the payment card via a NFC protocol.

16. The communication device according to claim 12, wherein the program instructions are operative to cause the processor to receive an input of biometric data from the cardholder on the communication device for verification against reference biometric data associated with the cardholder stored by the payment card, and to obtain the payment account data in response to a positive verification.

17. The communication device according to claim 12, wherein obtaining the payment account data comprises storing the payment account data in a secure memory, and wherein the program instructions are operative to cause the processor to allow retrieval of the payment account data from the secure memory in response to an authentication message, and deny retrieval thereof otherwise.

18. The communication device according to claim 17, wherein the program instructions are operative to cause the processor to receive the request for the input of payment account data via a first application, via which a payment transaction is to be carried out, to generate the authentication message based on the payment transaction, and to allow retrieval of the payment account data by the first application using the authentication message.

19. The communication device according to claim 18, wherein the payment transaction is for a purchase of products made by the cardholder via the first application.

20. The communication device according to claim 18, wherein the program instructions are operative to cause the processor to automatically populate the payment account data in the first application for display to the cardholder on the communication device.

21. The communication device according to claim 12, wherein the program instructions are operative to cause the processor to remove the payment account data from the communication device after the operation of transmitting the payment account data.

22. The communication device according to claim 21, wherein the program instructions are operative to cause the processor to remove the payment account data from the communication device in response to a notification of the payment transaction being successful.

23. A non-transitory computer-readable medium storing computer-readable instructions that, when executed, cause a processor of a communication device of a cardholder of a payment card to perform steps of a method for making a payment transaction over a payment network, the method comprising:
receiving, by the communication device, a request for an input of payment account data in respect of the payment transaction;
obtaining by the communication device in response to the request, the payment account data of the payment card using the RF communication module; and
transmitting the payment account data from the communication device to the payment network for processing the payment transaction.

24. (canceled)
